(19) United States
(12) Patent Application Publication
(10) Pub. No.: US 2026/0245390 A1
(43) Pub. Date: Aug. 20, 2026

(54) DETECTION OF INAUTHENTIC VISUAL CONTENT USING PHYSICS BASED CONSTRAINTS

(71) Applicant: Microsoft Technology Licensing, LLC, Redmond, WA (US)

(72) Inventors: Amit MANCHANDA, New Delhi (IN); Shubhojit Mallick, Haryana (IN); Nithya Ragupathy, Tamilnadu (IN); Akash Jain, Bhagalpur (IN); Harish Yenala, Hyderbad (IN)

(21) Appl. No.: 19/083,874

(22) Filed: Mar. 19, 2025

(30) Foreign Application Priority Data
Feb. 14, 2025 (IN) 202511012601

(51) Int. Cl. G06V 20/00; G06V 10/82

(52) U.S. Cl. CPC G06V 20/95; G06V 10/82

(57) ABSTRACT

The technology described herein is related to a machine-learning (ML) detection model that detects AI manipulated media, such as videos and images. The technology described herein uses machine learning algorithms to analyze videos and images to generate an authenticity rating. The detection model is trained to understand physics-based constraints. It is difficult to alter an image or generate an artificial image that adheres to the rules of physics in all respects. The detection model can identify possible deviations from the rules of physics in images and videos and use these differences to generate an authenticity metric. Physics-based constraints may include optics-awareness, gravity awareness, material property awareness, conservation of energy, and physical interaction awareness. The detection model is able to identify images and videos that violate the physical constraints. In aspects, the detection model may include a VAE (Variational Autoencoder) and a cGAN (Conditional Generative Adversarial Network) that work together.

### CROSS-REFERENCE TO RELATED APPLICATIONS

This application claims priority to Indian Patent Application No. 202511012601, filed on Feb. 14, 2025, which is incorporated herein by reference in its entirety.

### BACKGROUND

Generative artificial intelligence (AI) models (e.g., Large Language Models or “LLMs,” Diffusion models, Generative Adversarial Networks or “GANs,” etc.) develop quickly and demonstrate applicability to a wide range of applications and tasks. For example, generative AI models can provide support for various applications including generating videos and images based on natural language text descriptions. Furthermore, the functionality of generative AI models raises security concerns. For example, generative AI can be used to generate harmful or malicious content, such as deepfake videos and images. Increasingly, humans have difficulty distinguishing between real images and AI generated images. These instances highlight the potential for the use of generative AI to disseminate false information, engage in online harassment, or otherwise manipulate users with generated content.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The technology described herein is related to a machine-learning (ML) detection model that detects AI manipulated media, such as videos and images. The technology described herein uses machine learning algorithms to analyze media to generate an authenticity rating. Unaltered media are authentic and capture the ground truth of a scene, while altered or AI generated media are inauthentic. Inauthentic media may be generated by manipulating an authentic media or be entirely generated by AI. The authenticity rating can be used to measure the authenticity of digital media and provide a warning (or other action) when inauthentic media is detected. The technology protects the integrity of media in an increasingly digital world. By detecting manipulated media, the technology described herein helps prevent the spread of false information, ensuring that people have access to accurate and truthful content. The technology described herein enhances security by identifying potential threats posed by manipulated media such as identity theft, fraud, and other malicious activities. The technology described herein provides a reliable tool to verify the authenticity of media, such as videos and images.

In aspects, the detection model is trained to understand physics-based constraints. It is difficult to alter a media or generate an artificial media that adheres to the rules of physics in all respects. The detection model can identify possible deviations from the rules of physics in images and videos and use these differences to generate an authenticity metric. Physics-based constraints may include, for example, optics-awareness, gravity awareness, material property awareness, conservation of energy, and physical interaction awareness. Once trained, the detection model is able to identify media that violate the physical constraints.

In aspects, the detection model may include a VAE (Variational Autoencoder) and a cGAN (Conditional Generative Adversarial Network) that work together. The VAE includes an encoder and a decoder. At a high level, the encoder is trained to receive an image and generate a latent space that the decoder uses as input to reproduce the image. The technology described herein uses a physics-constrained encoder in the VAE to generate a physics-constrained latent space that enforces physical constraints, even if the input image violates the constraints. The output of the physics-constrained encoder is described herein as a physics-constrained latent space. The decoder then uses the physics-constrained latent space to generate a physics-constrained image. When an input image differs from the physics-constrained output image beyond a threshold amount it may be determined to be an inauthentic image. In aspects, an image generated by the cGAN may be analyzed instead of or in conjunction with the VAE generated image.

The cGAN includes a generator and a discriminator. At a high level, the generator receives noise with conditional inputs and generates an image. The discriminator determines whether the image produced is real or generated. When fully trained, the generator should produce images that the discriminator has difficulty identifying as generated. In aspects, the cGAN may use the physics-constrained latent space (or a sampling of it) generated by the VAE encoder as input to the generator. The image produced by the generator may then be compared to the original image. More differences between the generated image and the input image will be detected when the input image has been manipulated in a way that is inconsistent with the learned physics constraints.

In one aspect, the authenticity score is based on a comparison between the original image and the output image(s). In addition, areas of significant difference between the original image and generated image(s) may be highlighted in the original image, for example, with a bounding box. In addition to the bounding box, a text explanation of the differences may be generated. Initially, a model extracts key features from the image or video, identifying areas that appear manipulated.

The VAE and cGAN may be trained together using a multi-objective framework. In a multi-objective framework, the goal is to optimize multiple objectives simultaneously. The latent representation from the VAE is used as input to the generator. During training, gradients for all losses are computed and the parameters of the VAE and cGAN are updated using a weighted sum of the losses. This process may be repeated for multiple epochs, adjusting the weights of the losses as needed to balance the objectives.

### BRIEF DESCRIPTION OF THE DRAWINGS

The technology described herein is illustrated by way of example and not limitation in the accompanying figures in which like reference numerals indicate similar elements and in which:

FIG. 1 is a diagram of a computing system suitable for implementations of the technology described herein;

FIG. 2 is a block diagram of an example operating environment for detection model, in accordance with an aspect of the technology described herein;

FIG. 3 is a diagram illustrating an inauthenticity warning, in accordance with an aspect of the technology described herein;

FIG. 4 is a diagram illustrating an inauthenticity detail view, in accordance with an aspect of the technology described herein;

FIG. 5 is a flow diagram showing a method of detecting an inauthentic image, in accordance with an aspect of the technology described herein;

FIG. 6 is a flow diagram showing a method of detecting an inauthentic image, in accordance with an aspect of the technology described herein;

FIG. 7 is a flow diagram showing a method of detecting an inauthentic image, in accordance with an aspect of the technology described herein; and

FIG. 8 is a block diagram showing a computing device suitable for implementations of the technology described herein.

### DETAILED DESCRIPTION

The various technologies described herein are set forth with sufficient specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The technology described herein is related to a machine-learning (ML) detection model that detects AI manipulated media, such as videos and images. The technology described herein uses machine learning algorithms to analyze media to generate an authenticity rating. Unaltered media are authentic and capture the ground truth of a scene, while altered or AI generated media are inauthentic. Inauthentic media may be generated by manipulating an authentic media or be entirely generated by AI. The authenticity rating can be used to measure the authenticity of digital media and provide a warning (or other action) when inauthentic media is detected. The technology protects the integrity of media in an increasingly digital world. By detecting manipulated media, the technology described herein helps prevent the spread of false information, ensuring that people have access to accurate and truthful content. The technology described herein enhances security by identifying potential threats posed by manipulated media such as identity theft, fraud, and other malicious activities. The technology described herein provides a reliable tool to verify the authenticity of media, such as videos and images.

mediaIn aspects, the detection model is trained to understand physics-based constraints. It is difficult to alter a media or generate an artificial media that adheres to the rules of physics in all respects. The detection model can identify possible deviations from the rules of physics in images and videos and use these differences to generate an authenticity metric. Physics-based constraints may include, for example, optics-awareness, gravity awareness, material property awareness, conservation of energy, and physical interaction awareness. Physics-based constraints may include optics-awareness, gravity awareness, material property awareness, conservation of energy, and physical interaction awareness units. Optics awareness checks for physically accurate light scattering, reflection, and refraction. Gravity awareness ensures that objects follow expected physical trajectories and constraints, particularly related to gravity. Material property awareness ensures that surfaces and textures behave consistently with physical material properties (e.g., roughness, reflectivity). Conservation of energy awareness checks if lighting intensity is consistent with object shading. Physical interaction awareness ensures that objects should behave in ways that obey conservation of momentum, friction, etc. For example, objects in motion should not move in ways that violate basic physical principles. Once trained, the detection model is able to identify media that violate the physical constraints.

In aspects, the detection model may include a VAE (Variational Autoencoder) and a cGAN (Conditional Generative Adversarial Network) that work together. The encoder of the VAE and the generator of the cGAN are physics constrained. The technology described herein may include a VAE with physics-constrained layers in the decoder, which ensures that the learned latent space can represent physical data, and then use cGAN to generate new data conditioned on specific inputs while enforcing physics constraints within the generator.

The VAE includes an encoder and a decoder. At a high level, the encoder is trained to receive an image and generate a latent space that the decoder uses as input to reproduce the image. The technology described herein uses a physics-constrained encoder in the VAE to generate a physics-constrained latent space that enforces physical constraints, even if the input image violates the constraints. The output of the physics-constrained encoder is described herein as a physics-constrained latent space. The decoder then uses the physics-constrained latent space to generate a physics-constrained image. When an input image differs from the physics-constrained output image beyond a threshold amount it may be determined to be an inauthentic image. In aspects, an image generated by the cGAN may be analyzed instead of or in conjunction with the VAE generated image.

The physics-constrained encoder may include one or more layers responsible for constraining the latent space to one or more physical constraints. A layer may be trained using a loss function that is specific to a rule of physics. In aspects, a single layer may be trained on multiple physical constraints. In other aspects, each physical constraint may have a dedicated layer within the VAE encoder.

The cGAN includes a generator and a discriminator. At a high level, the generator receives noise with conditional inputs and generates an image. The discriminator determines whether the image produced is real or generated. When fully trained, the generator should produce images that the discriminator has difficulty identifying as generated. In aspects, the cGAN may use the physics-constrained latent space (or a sampling of it) generated by the VAE encoder as input to the generator. The generator may also be modified to ensure it operates on the physics-constrained latent space. The modification involves adapting the generator to respect the geometry and lighting encoded in the latent space, ensuring that the generated output obeys the same physical principles as the input. The generator may be adapted using images that are not physically constrained. The training image may be input to the VAE encoder, which produces a physically constrained latent space once trained. The physically constrained latent space is provided as input to the generator along with conditional input, which may be a bounding box highlighting a portion of the image that is not physically constrained. A physics-based loss function may be used to train generator to fix the portion of the image that is not physically constrained. In this way, the generator learns to produce physically constrained images. Once trained, the image produced by the generator may then be compared to the original image. More differences between the generated image and the input image will be detected when the input image has been manipulated in a way that is inconsistent with the learned physics constraints because the generator will have fixed the portions of the image that are not physically constrained.

In one aspect, the authenticity score is based on a comparison between the original image and the output image(s). In addition, areas of significant difference between the original image and generated image(s) may be highlighted in the original image, for example, with a bounding box.

In addition to the bounding box, a text explanation of the differences may be generated. Initially, a model extracts key features from the image or video, identifying areas that appear manipulated. Using techniques like Gradient-weighted Class Activation Mapping (Grad-CAM), the model generates a heatmap highlighting suspicious areas. The model analyzes the heatmap to recognize specific patterns or anomalies, such as unnatural eye movements or inconsistent lighting. The model uses a set of predefined rules and templates to convert these patterns into text explanations. For example, if the heatmap shows high activity around the eyes, the model can use a template like “The eyes appear unnatural.” Advanced NLG techniques help refine these templates into coherent and natural-sounding sentences. The text explanation is generated, detailing the specific features and areas that contributed to the detection. For example, “Our analysis indicates that the eyes in this image exhibit unnatural characteristics, suggesting possible manipulation.”

The VAE and cGAN may be trained together using a multi-objective framework. In a multi-objective framework, the goal is to optimize multiple objectives simultaneously. For training a VAE and cGAN together, the objectives could include, reconstruction loss (ensuring the VAE can accurately reconstruct the input data), Kullback-Leibler (KL) divergence in the VAE, adversarial loss in the cGAN (ensuring the cGAN generates realistic data that the discriminator cannot distinguish from real data), and conditional loss (ensuring the generated data matches the conditioning information). The latent representation from the VAE is used as input to the generator, conditioned on the additional information. During training, gradients for all losses are computed and the parameters of the VAE and cGAN are updated using a weighted sum of the losses. This process may be repeated for multiple epochs, adjusting the weights of the losses as needed to balance the objectives.

The technology described herein can be used with services and applications that involve images. Example applications and/or services that may use the technology described herein may include a search engine, an email application or service, social media application or service, instant messaging applications or services, text applications or services, video conferencing applications or services, storage applications or services, video sharing applications or services, cloud computing platforms, word processing applications or services, presentation applications or services, and a web browser. The technology described herein may have a server component and/or client component, depending on the application or service. For example, a browser may have a plug-in that generates a notice when a manipulated image is detected. The plug-in could also provide images to the server-based detection model for analysis.

The technologies herein are described using key terms wherein definitions are provided. However, the definitions of key terms are not intended to limit the scope of the technologies described herein.

In an example, a neural network is a computational model that consists of layers of nodes, or “neurons,” each receiving input, processing it, and passing the output to the next layer. Neural networks can include different types of layers. Example layer types include convolutional, activation, pooling, fully connected, batch normalization, dropout, recurrent layers, feedforward layers, embedding layers, and attention layers. The VAE and cGAN can include neural networks.

In an example, a “language model” is a set of statistical or probabilistic functions that performs Natural Language Processing (NLP) in order to understand, learn, and/or generate human natural language content. A language model is one example of a neural network. For example, a language model can be a tool that determines the probability of a given sequence of words occurring in a sentence (e.g., via NSP or MLM) or natural language sequence. Simply put, it can be a tool which is trained to predict the next word in a sentence. A language model is called a large language model (“LLM”) when it is trained on enormous amount of data. Some examples of LLMs are GOOGLE's BERT and OpenAI's GPT-2 and GPT-3. GPT-3, and GPT-4, which has over 175 billion parameters trained on over 570 gigabytes of text. These models have capabilities ranging from writing an essay to generating complex computer codes-all with limited to no supervision. Accordingly, an LLM is a deep neural network that is very large (billions to hundreds of trillions of parameters) and understands, processes, and produces human natural language by being trained on massive amounts of text. These models can predict future words in a sentence letting them generate sentences similar to how humans talk and write. In some embodiments, the LLM is pre-trained (e.g., via NSP and MLM on a natural language corpus to learn English) without having been fine-tuned, but rather uses prompt engineering/prompting/prompt learning using one-shot or few-shot examples. A language model may perform various tasks, such as machine translation, natural language summary, question answering, and sentiment analysis.

In an example, a “natural language summary” as described herein refers to text summarization. Text summarization (or automatic summarization or NLP text summarization) is the process of breaking down text (e.g., several paragraphs) into smaller text (e.g., one sentence or paragraph). In other words, text summarization is the process of distilling the most important information from a source (or sources) to produce an abridged version for a particular user (or users) and task (or tasks). This method extracts vital information while also preserving the meaning of the text. This reduces the time required for grasping lengthy pieces such as articles without losing vital information, for example. For example, using extraction summarization, some embodiments, using NLP, detect key chunks of natural language text, extracting or cutting them out, then stitching them back together to create a shortened form of the dataset. For instance, a sentence in the dataset may read, “I'm heading to the supermarket by taking Ray road. Hopefully there will not be as much traffic at that time. I'm going to buy fruit.” Extraction summarization may work by reducing the characters to “I'm heading to the supermarket. I'm going to buy fruit.” In another example, abstractive summarization works by generating new sentences (or other natural language characters) from the original dataset. For example, using the original dataset described above, the summarization may be, “I'm heading to the store to buy fruit,” where “store” is a new word input into the new sentence (e.g., based on NLP semantic analysis and/or Named Entity Recognition NER and “I'm going” is removed from the original sentence. NER is an information extraction technique that identifies and classifies tokens/words or “entities” in natural language text into predefined categories. Such predefined categories may be indicated in corresponding tags or labels, which can be used in summaries. Entities can be, for example, names of people, specific organizations, specific locations, specific times, specific quantities, specific monetary price values, specific percentages, specific pages, and the like.

In an example, a Variational Autoencoder (VAE) is a generative model that learns to compress and reconstruct input data by encoding a continuous, probabilistic latent space. The two major components of a VAE are an encoder and a decoder. The encoder in a VAE is responsible for mapping input data to a latent space. Unlike traditional autoencoders that produce a fixed point in the latent space, the encoder in a VAE outputs parameters of a probability distribution—typically the mean and variance of a Gaussian distribution. The decoder reconstructs the original data from the compressed representation in the latent space. By sampling from the distribution provided by the encoder, the decoder generates new data instances that resemble the original input data.

Unlike traditional autoencoders that encode a discrete, fixed representation of latent variables, VAEs encode a continuous, probabilistic representation of that latent space. This enables VAEs to not only accurately reconstruct the exact original input but also generate new data samples that resemble the original input data.

In an example, a Generative Adversarial Network (GAN) is a class of machine learning frameworks. In a GAN, two neural networks contest with each other in the form of a zero-sum game. The two neural networks may be described herein as a generator and a discriminator. GANs work by having the generator and discriminator play an adversarial game. The generator learns to create plausible data, and the discriminator learns to distinguish the generator's fake data from real data. The discriminator penalizes the generator for producing implausible results. Initially, the generator produces obviously fake data, and the discriminator quickly learns to tell that it's fake. As training progresses, the generator gets better at producing output that can fool the discriminator. If the generator training goes well, the discriminator gets worse at telling the difference between real and fake data. For example, a GAN trained on photographs can generate new photographs that look at least superficially authentic to human observers, having many realistic characteristics.

Having briefly described an overview of aspects of the technology described herein, an operating environment in which aspects of the technology described herein may be implemented is described below to provide a general context for various aspects.

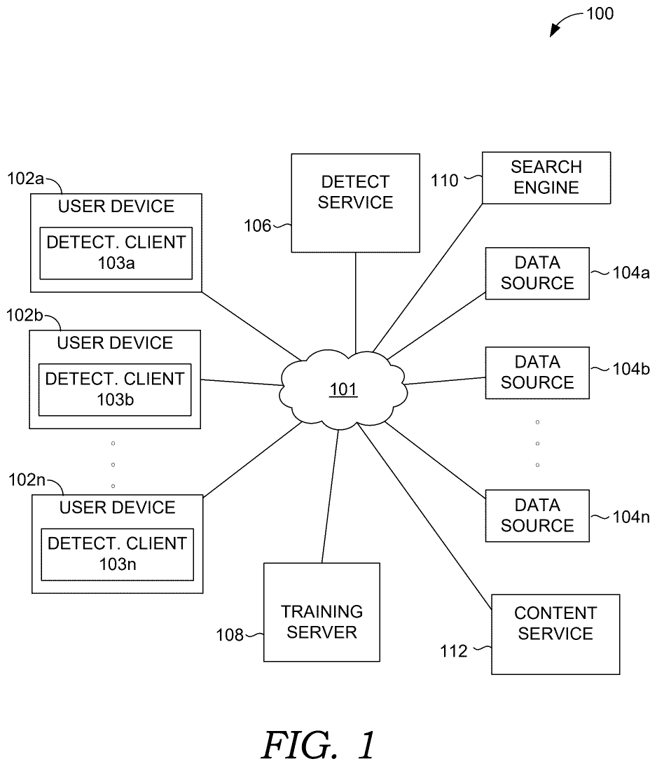

Turning now to FIG. 1, a block diagram is provided showing an example operating environment 100 in which some embodiments of the present disclosure can be employed. This and other arrangements described herein are set forth only as examples. Other arrangements and elements (for example, machines, interfaces, functions, orders, and groupings of functions) can be used in addition to or instead of those shown, and some elements can be omitted altogether for the sake of clarity. Further, many of the elements described herein are functional entities that are implemented as discrete or distributed components or in conjunction with other components, and in any suitable combination and location. Various functions described herein as being performed by one or more entities are carried out by hardware, firmware, and/or software. For instance, some functions are carried out by a processor executing instructions stored in memory.

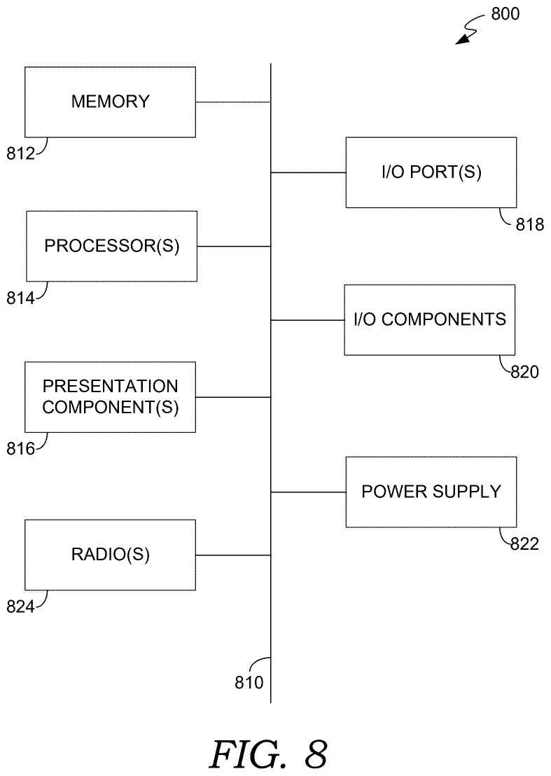

Among other components not shown, example operating environment 100 includes several user computing devices, such as user devices 102a through 102n; several data sources, such as data sources 104a and 104b through 104n; detection service 106; detection training server 108; search engine 110; content service 112; and network 101. Each of the components shown in FIG. 1 is implemented via any type of computing device, such as computing device 800 illustrated in FIG. 8. In one embodiment, these components communicate with each other via network 101, which includes, without limitation, one or more local area networks (LANs) and/or wide area networks (WANs). In one example, network 101 comprises the internet, intranet, and/or a cellular network, amongst any of a variety of possible public and/or private networks.

Any number of user devices, servers, and data sources can be employed within operating environment 100 within the scope of the present disclosure. Each may comprise a single device or multiple devices cooperating in a distributed environment. For instance, detection service 106 may be provided via multiple devices arranged in a distributed environment that collectively provides the functionality described herein. Additionally, other components not shown may also be included within the distributed environment.

User devices 102a, 102b, through 102n can be client user devices on the client-side of operating environment 100, while detection service 106 and training server 108 can be on the server-side of operating environment 100. The user devices may be described as client devices and/or edge devices herein. Detection service 106 can comprise server-side software designed to work in conjunction with client-side software on user devices 102a through 102n to implement any combination of the features and functionalities discussed in the present disclosure. For example, the user devices 102a through 102n may include a detection client 103a through 103n. The detection client may work with the content service 112 to provide images to a user. Example applications and/or services that may use the technology described herein may include a search engine, an email application or service, social media application or service, instant messaging application or service, text application or service, video conferencing application or service, storage applications or service, video sharing applications or service, cloud computing platforms, word processing application or service, presentation application or service, and a web browser. The technology described herein may have a server component, such as content service 112, and/or client component, depending on the application or service.

In one aspect, the detection service 106 hosts a detection model that helps the detection clients 103a through 103n to provide user interface features that alert the user to fake images. This division of operating environment 100 is provided to illustrate one example of a suitable environment, and there is no requirement for each implementation that any combination of detection service 106, training server 108 and user devices and 102a through 102n remain as separate entities.

In some embodiments, user devices 102a through 102n comprise any type of computing device capable of use by a user. For example, in one embodiment, user devices 102a through 102n are the type of computing device 800 described in relation to FIG. 8. By way of example and not limitation, a user device is embodied as a personal computer (PC), a laptop computer, a mobile device, a smartphone, a tablet computer, a virtual-reality (VR) or augmented-reality (AR) device or headset, a handheld communication device, an embedded system controller, a consumer electronic device, a workstation, any other suitable computer device, or any combination of these delineated devices.

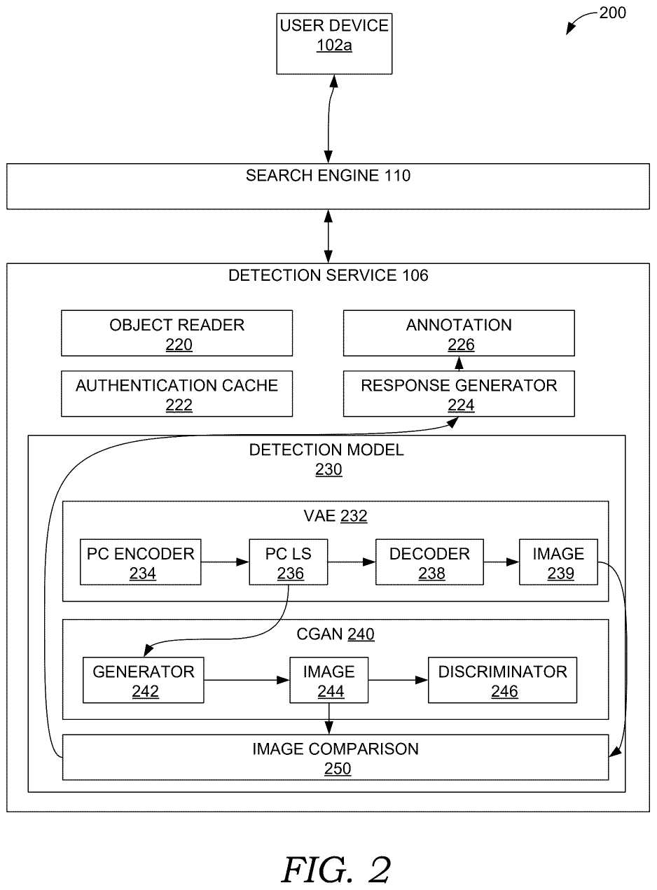

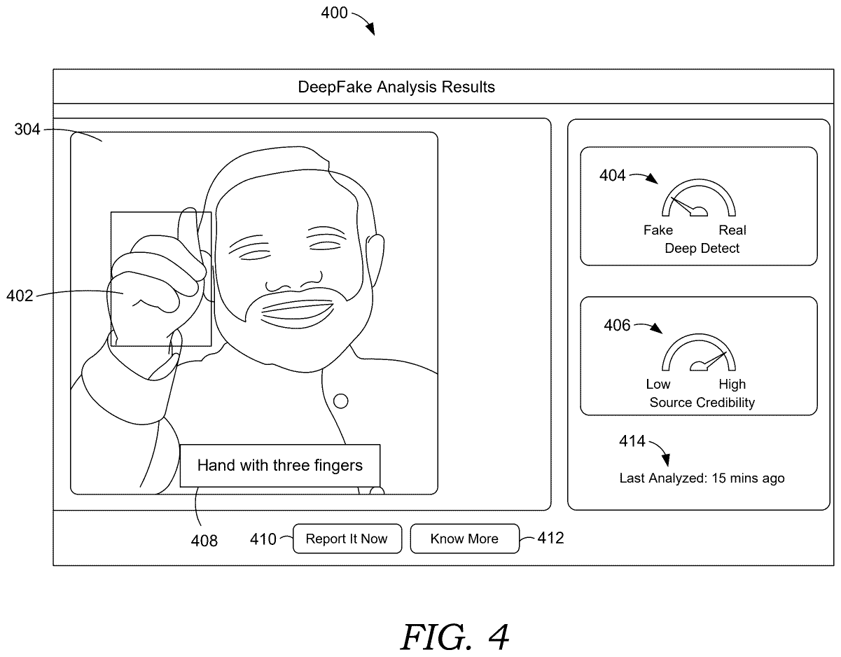

In some embodiments, data sources 104a and 104b through 104n comprise data sources and/or data systems, which are configured to make data available to any of the various constituents of operating environment 100 or environment 200 described in connection to FIG. 2. The data sources may include training data for the training server 108 or model trainer and/or input and output from a trained model. The data sources can include image sources, such as social networks, websites, online marketplaces, image hosting services, stock photo libraires, and online forums. The data sources may be described as image sources with reference to FIG. 4 and elsewhere. Different sources may have a reliability score. The overall reputation of the source (e.g., website or domain) is considered. Sites with a history of providing accurate and trustworthy information are ranked higher.

The training server 108 may train a neural network, such as an LLM, before it is deployed to a client device and server. Certain data sources 104a and 104b through 104n are discrete from user devices 102a through 102n and detection service 106 and training server 108 or are incorporated and/or integrated into at least one of those components. In one embodiment, one or more of data sources 104a and 104b through 104n comprise one or more sensors, which are integrated into or associated with one or more of the user device(s) 102a through 102n or server 106. For example, the data sources could include a web camera used to interact with a virtual environment.

The detection service 106 receives an image and assigns it an authenticity score. The authenticity score may be generated by machine learning model. v detection model may include a VAE (Variational Autoencoder) and a cGAN (Conditional Generative Adversarial Network) that work together. The VAE includes an encoder and a decoder, both of which may comprise neural networks. At a high level, the encoder is trained to receive an image and generate a latent space that the decoder uses as input to reproduce the image. The technology described herein uses a physics-constrained encoder in the VAE to generate a physics-constrained latent space that enforces physical constraints, even if the input image violates the constraints. The output of the physics-constrained is described herein as a physics-constrained latent space. The decoder then uses the physics-constrained latent space to generate a physics-constrained image. When an input image differs from the physics-constrained output image beyond a threshold amount it may be determined to be an inauthentic image. In aspects, an image generated by the cGAN may be analyzed instead of or in conjunction with the VAE generated image.

The physics-constrained encoder may include one or more layers responsible for constraining the latent space to one or more physical constraints. A layer may be trained using a loss function that is specific to a rule of physics. In aspects, a single layer may be trained on multiple physical constraints. In other aspects, each physical constraint may have a dedicated layer within the VAE encoder.

The cGAN includes a generator and a discriminator. At a high level, the generator receives noise with conditional inputs and generates an image. The discriminator determines whether the image produced is real or generated. When fully trained, the discriminator should have difficulty telling whether images produced by the generator are real or fake. In aspects, the cGAN may use the physics-constrained latent space (or a sampling of it) generated by the VAE encoder as input to the generator. The image produced by the generator may then be compared to the original image. More differences between the generated image and the input image will be detected when the input image has been manipulated in a way that is inconsistent with the learned physics constraints.

In addition, the detection service 106 may identify areas of an image that appeared to be inauthentic. The detection service 106 may also generate a textual explanation of the inauthentic portion. These features are described in more detail with reference to the annotation component 226 of FIG. 2.

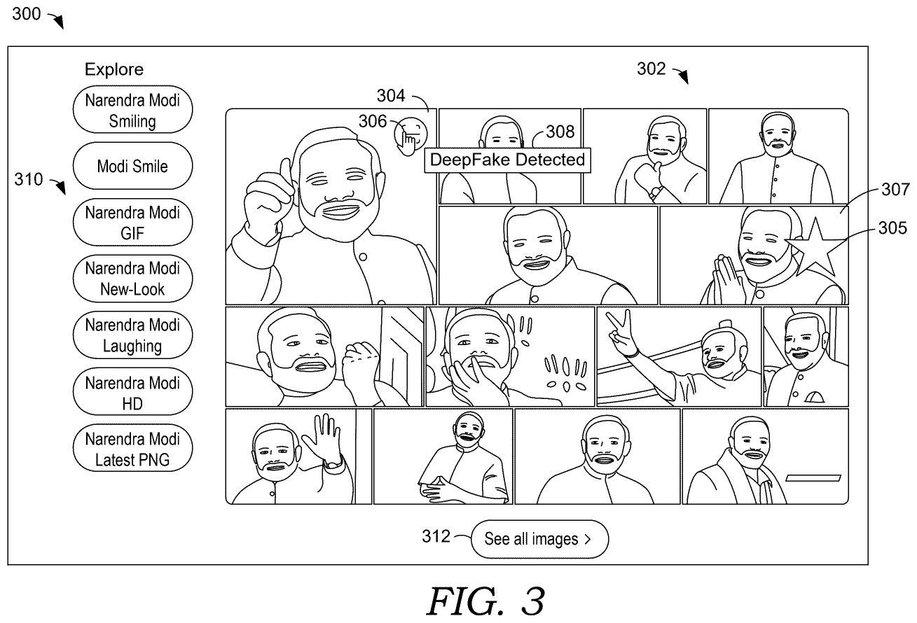

The search engine 110 may interact with the detection service 106 to identify inauthentic images. As shown in FIGS. 3 and 4, images in the search results may be associated with an authenticity icon when the detection service 106 determines the image is authentic. Images in the search results may be associated with the inauthenticity icon or warning when the detection service 106 determines the images inauthentic. Images with a mid-range authenticity score may not be assigned either icon.

The search engine 110 may comprise one or more crawlers, one or more indexers, a query processor, and ranker, and a user interface. The crawler scans the web to collect images and their associated metadata (like alt text, captions, and surrounding text). The collected images and metadata are stored in a database. The indexer organizes this data to make it easily searchable. The query processor interprets the user's search query, identifying keywords and understanding the context. The ranker uses one or more algorithms to determine the relevance of images based on various factors like keyword match, image quality, user engagement, and more. The front-end interface, which may be accessed through a web browser or application, is where users input their queries and view the search results. In aspects, the technology described herein may use the detection service 106 to analyze images that are in the search engines data store. The generated score may be associated with the image. In this way, the detection analysis does not need to be made in real time for some images. In other cases, the analysis may be triggered when an image that is not associated with an authenticity score is determined to be relevant to a query. The same mixture of advanced analysis and near real-time analysis may be used with other applications, such as social media applications. In this way, a previously analyzed image does not need to be reanalyzed.

The training server 108 is responsible for training the detection model, such as detection model 230, of the detection service 106. The detection model is trained to understand physics-based constraints. It is difficult to alter an image or generate an artificial image that adheres to the rules of physics in all respects. The detection model can identify possible deviations from the rules of physics in images and videos and use these differences to generate an authenticity metric. Physics-based constraints may include optics-awareness, gravity awareness, material property awareness, conservation of energy, and physical interaction awareness. Optics awareness checks for physically accurate light scattering, reflection, and refraction. Gravity awareness ensured that objects follow expected physical trajectories and constraints, particularly related to gravity. Material property awareness ensures that surfaces and textures behave consistently with physical material properties (e.g., roughness, reflectivity). Conservation of energy awareness checks if lighting intensity is consistent with object shading. Physical interaction awareness ensures that objects should behave in ways that obey conservation of momentum, friction, etc. For example, objects in motion should not move in ways that violate basic physical principles. Once trained, the detection model is able to identify images and videos that violate the physical constraints.

As mentioned, the detection model may include a VAE and cGAN. As a starting point, the two models may be trained conventionally to generate images without regard for physics constraints. In one aspect, they are trained separately. Alternatively, the VAE and cGAN may be trained together using a multi-objective framework. In a multi-objective framework, the goal is to optimize multiple objectives simultaneously. For training a VAE and cGAN together, the objectives could include reconstruction loss (ensuring the VAE can accurately reconstruct the input data), KL divergence in the VAE, adversarial loss in the cGAN (ensuring the cGAN generates realistic data that the discriminator cannot distinguish from real data), and conditional loss (ensuring the generated data matches the conditioning information). The latent representation from the VAE is used as input to the generator, conditioned on the additional information. During training, gradients for all losses are computed and the parameters of the VAE and cGAN are updated using a weighted sum of the losses. This process may be repeated for multiple epochs, adjusting the weights of the losses as needed to balance the objectives. Once the two models are sufficiently trained, they may be physics constrained.

In one aspect, the starting point for training the VAE encoder to be physics constrained is to identify a latent vector from the latent space that represents a desired physical characteristic, such as lighting. Different methods can be used to identify the lighting vector. These methods include latent space manipulation, feature extraction, and differential rendering. Differential rendering involves comparing rendered images under different lighting conditions to isolate the effects of lighting changes. This technique can be applied to the latent space of a VAE to identify the dimensions that correspond to lighting. Feature extraction techniques like principal component analysis or t-distributed Stochastic Neighbor Embedding (t-SNE) can be applied to the latent space to identify the dimensions related to lighting.

Once the latent vector is identified, the encoder may be trained to output latent vectors that are constrained to described physical characteristic. This may be done through fine-tune training using a physics specific loss function. Using the light example, a loss function may be used to penalize the encoder when the light vector in the generated latent space is not consistent with physics. For lighting, the loss vector may be based on a Lambertian reflection model, especially if the image includes matte surfaces. The Lambertian reflection model describes how light reflects off a perfectly diffuse surface, meaning the surface scatters light equally in all directions. The cosine law of the Lambertian reflection model specifies that the intensity of the reflected light is proportional to the cosine of the angle between the incident light and the surface normal. The loss function would determine when the light vector in the latent space produces an image that violates the cosine law and penalize it. Eventually, the encoder will learn to produce latent space that is consistent with the cosine law.

In aspects, the physics constraint is trained into a layer of the encoder. A layer that is trained to enforce one or more physics constraints may be described as a physics regulation layer. The purpose of the physics regulation layer is to force the encoder to output a latent space where a vector representing a physical characteristic conforms to the physics constraint as measured by a model tied to a physics-based loss function. This may be accomplished by freezing other layers during the fine tuning used to generate a physics constraint. This results in an encoder with a layer dedicated to one or more physical restraints. The process described above for lighting can be used with the above listed physics characteristics.

For depth consistency, the latent vector communicating depth can be isolated. Then a loss function based on depth regularization can be used to train the encoder. As with lighting, a single layer may be trained. In one aspect, a monocular depth estimation model is generated for an input image and the output image generated by the decoder. The loss function may be based on the differences in the models and have the goal of eliminating differences. In one aspect images with faces are used for training, a depth regularization model estimates the depth of each pixel in the face image. The training can create a loss if the 3D depth model in a rendered image differs from the 3D depth model in the input image. In this example, the training data would include real images. Again, a single layer may be trained.

The technology described herein may work with videos. In one aspect, each frame of the video may be analyzed. However, sequential frames may also be analyzed for motion consistency. While working with sequences (e.g., video or facial movements), the detection model regularized the latent representations of objects and features across frames to ensure smooth and realistic motion. Temporal continuity was ensured by penalizing large jumps or unrealistic deformations between adjacent frames. In one aspect, the motion consistency may be based on a Fréchet video motion distance (FVMD) model.

Geometrical consistency loss ensures that object features do not change beyond various parameters in video frames. The layers of the encoder were able to enforce that the latent space captures the relationship between key facial features in 3D space, such as the relative positions of eyes, nose, and mouth. This may be done by using a pre-trained face landmark model to estimate these relations in the latent space. The loss function penalizes a latent space that produces features outside the relations.

The generator of the cGAN can also include physics-constrained layer(s). As with the encoder, the starting point may be a fully trained cGAN generator trained without reference to physical constraints. The training data for the cGAN may include images that are not physics constrained in one or more aspects (e.g., lighting, gravity) and a conditional label in the form of a bounding box covering a portion of the training image that is not physically constrained. The layers of the generator that have already been trained may be frozen, while the physics-constrained layer in the generator is trained. The generator may include multiple physics-constrained layers. In one aspect, each physics-constrained layer is responsible for constraining the image generated for a single physical characteristic. In other aspects, a physics-constrained layer may be responsible for multiple physical characteristics.

Training of the physics-constrained layer may occur with one-characteristic at a time as each characteristic may use a different physics-constrained loss function and corresponding images. During training, the generator will learn to produce an image that is physics-constrained by reducing the loss of the physics-constrained loss function. This may be combined with the loss function used at the discriminator. In other words, the generated images should be physics-constrained and appear not to be AI generated. As mentioned, each training image may have a portion that is not physics-constrained for the characteristic being learned. The training process may be repeated for each physical characteristic being learned. Each characteristic may have a set of training images that include portions that do not conform to the physical characteristic being learned and each physical characteristic may use a specific loss function that detects when an image includes portions that do not conform to the physical characteristic.

Operating environment 100 can be utilized to implement one or more of the components of environment 200, as described in FIG. 2. Operating environment 100 can also be utilized for implementing aspects of methods 500, 600, and 700 in FIGS. 4, 5, and 6, respectively.

Referring now to FIG. 2 with FIG. 1, a block diagram is provided showing aspects of an example detection environment suitable for implementing some embodiments of the disclosure and designated generally as environment 200. The environment 200 includes the detection service 106, the user device 102a, and the search engine 110. A high level, the user device 102a may submit a query to the search engine 110. The search engine 110 identifies one or more images are relevant to the query. The search engine 110 then provides the images and/or identification information for the images to the detection service 106. The detection service 106 may respond with an authenticity score for each image submitted to the detection service 106. In addition, the annotation component 226 may provide an explanation for portions of an image that appear to be inauthentic. As mentioned, the detection service 106 may store the results of a previous analysis. The previous analysis may be stored in the authentication cache 222. Accordingly, in response to receiving information about an image the detection service 106 may determine if the image has been analyzed previously. If the image has been previously analyzed, the relevant analysis for the image may be retrieved from the authentication cache 222 in provided to the search engine 110. If an image is not found in the authentication cache 222, and the image may be sent to the detection model 230 for analysis.

The detection model 230 includes a VAE 232, a cGAN 240, and an image comparison component 250, that work together. The VAE includes a physics-constrained encoder 234 and a decoder 238. The physics-constrained encoder 234 receives an image and generate a physics-constrained latent space 236 that the decoder 238 uses as input to generate a VAE image 239. In one aspect, the input image and the output image are compared by the image comparison component 250. When an input image differs from the VAE image 239 beyond a threshold amount it may be determined to be an inauthentic image. In aspects, an cGAN image 244 may be analyzed instead of or in conjunction with the VAE generated image.

As described, the physics-constrained encoder may include one or more layers responsible for constraining the latent space to one or more physical constraints. A layer may be trained using a loss function that is specific to a rule of physics. In aspects, a single layer may be trained on multiple physical constraints. In other aspects, each physical constraint may have a dedicated layer within the VAE encoder.

The cGAN 240 includes a generator 242 and a discriminator 246. The generator receives the physics-constrained latent space 236 (or a sampling of it) as input to the generator 242. The cGAN image 244 produced by the generator 242 may then be compared to the original image by the image comparison component 250. More differences between the generated image and the input image will be detected when the input image has been manipulated in a way that is inconsistent with the learned physics constraints. The discriminator 246 is used during training but may not be used during the analysis.

The image comparison component 250 may use different techniques to compare the input image with the VAE image 239 and/or the output cGAN image 244. These techniques include mean squared error (MSE), structural similarity index (SSIM), peak signal-to-noise ratio (PSNR), histogram comparison, feature matching, and the use of a deep learning models. MSE calculates the average squared difference between the pixel values of the two images. A lower MSE indicates higher similarity. SSIM assesses the similarity based on luminance, contrast, and structure. It may be more aligned with human visual perception compared to MSE. PSNR measures the ratio between the maximum possible power of a signal and the power of corrupting noise. Higher PSNR values indicate greater similarity. Histogram comparison compares the color histograms of the images. Methods like correlation, chi-square, and intersection can be used to compare histograms. Feature matching techniques like SIFT (Scale-Invariant Feature Transform) and SURF (Speeded-Up Robust Features) detect and match key points in the images. Deep learning models, such as convolutional neural networks (CNNs) can be trained to extract high-level features from images and measure similarity based on these features. In aspects, a similarity score can serve as the authenticity score or be used to derive the score. If similarity scores are generated for the VAE image 239 and the cGAN image 244, then the two scores may be combined with or without weights. For example, it may be desirable to give more weight to the similarity score for the cGAN image 244. In some aspects, only the cGAN image 244 is used. In others, only the VAE image 239 is used.

The annotation component 226 may identify areas of significant difference between the original image and generated image(s). These areas represent manipulated portions and may be highlighted in the original image, for example, with a bounding box. In one aspect, initially, a model extracts key features from the image or video, identifying areas that appear manipulated. Using techniques like Gradient-weighted Class Activation Mapping (Grad-CAM), the model generates a heatmap highlighting suspicious areas. The model analyzes the heatmap to recognize specific patterns or anomalies, such as unnatural eye movements or inconsistent lighting. The model uses a set of predefined rules and templates to convert these patterns into text explanations. For example, if the heatmap shows high activity around the eyes, the model can use a template like “The eyes appear unnatural.” Advanced NLG techniques help refine these templates into coherent and natural-sounding sentences. The text explanation is generated, detailing the specific features and areas that contributed to the detection. For example, “Our analysis indicates that the eyes in this image exhibit unnatural characteristics, suggesting possible manipulation.” The annotation component may provide the bounding box and text to the response generator, which provides the response to the search engine. The search engine can then provide the authenticity score to the user, as shown in FIGS. 3 and 4.

Turning now to FIG. 3, a search results interface 300 showing images returned in response to a query is shown, in accordance with aspects of the technology described herein. The search results 302 may be provided by a search engine, such as search engine 110, described previously. In this example, one or more images presented in the search results are analyzed by the detection model to determine whether the image is authentic. As mentioned, the analysis of any one image could occur in near real time or in the past. If a relevant image had been previously analyzed, then the result of the previous analysis could be used to label the search results 302. If a relevant image had not been analyzed previously, then an analysis by the detection model could be performed in conjunction with presentation of the search result.

In one aspect, an authenticity icon 305, maybe presented in association with an image 307 that has been determined to be authentic. A warning, such as inauthenticity icon 306, maybe presented in association with an image that is determined to be inauthentic. Though not shown for the sake of simplicity, each image presented may be associated with the inauthenticity icon or the authenticity icon. In other aspects, some images are associated with an icon while others are not. For example, images with an authenticity score in a certain range associated with a high confidence may be presented with an inauthenticity warning, while images with an authenticity score in another range associated with a high confidence in authenticity are presented with an authenticity icon. Images with authenticity scores falling in a middle range between authenticity and inauthenticity may not be associated with an icon.

Upon hovering over the inauthenticity warning icon 306, a warning explanation 308 may be provided. The warning explanation 308 explains the purpose of the inauthenticity warning icon 306. Though not shown, a corresponding explanation may be provided upon hovering over the authenticity icon 305. Finally, the search results interface 300 includes an exploration interface 310 and a control 312 to view more images.

Turning now to FIG. 4, an inauthenticity detail interface 400 is shown, in accordance with aspects of the technology described herein. The inauthenticity detail interface 400 shows image 304 from FIG. 3. A bounding box 402 highlights a portion of the image 304 that appears to be inauthentic or manipulated. Though only one bounding box is shown in FIG. 4, each area appearing to be inauthentic may be highlighted with a bounding box if more than one area is detected. In addition to the bounding box 402, a textual explanation 408 of the apparent manipulation is provided. A reporting control 410 allows the user to confirm that the image 304 appears to be inauthentic. This reporting may be used by the search engine to confirm the inauthenticity of the image 304. Selecting the know more control 412 can provide background information about the authenticity determination process, how reporting information is used, and other information about the authenticity report.

The inauthenticity metric interface 404 indicates that there is a high confidence of inauthenticity. The inauthenticity metric interface 404 communicates the authenticity metric (or a score derived from the metric) to the user. The source credibility interface 406 communicates a credibility measure for the source of the image. The search engine may reduce the credibility of a source as more inauthentic images are associated with the source. The user confirmation provided by the reporting control 410 may further lower the source credibility score. Finally, a freshness indicator 414 communicates when the inauthenticity score and the source credibility score were last calculated.

### EXAMPLE METHODS

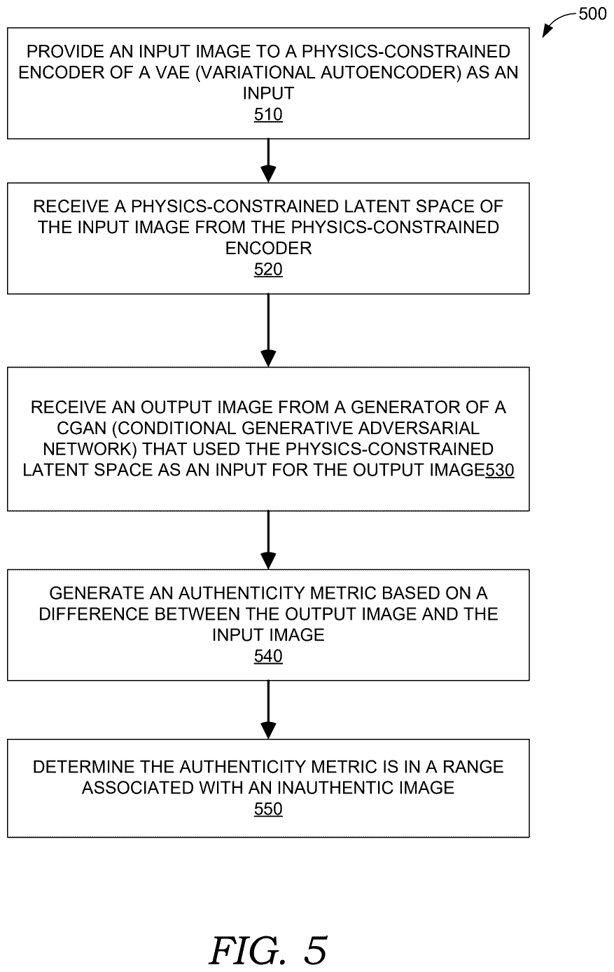

Now referring to FIGS. 5, 6 and 7, each block of methods 500, 600, and 700, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The method may be provided by an operating system. In addition, methods 500, 600, and 700 are described, by way of example, with respect to FIGS. 1-4. However, these methods may additionally or alternatively be executed by any one system, or any combination of systems, including, but not limited to, those described herein.

FIG. 5 is a flow diagram showing a method 500 of detecting an inauthentic image, in accordance with some embodiments of the present disclosure. Method 500 may be performed on or with systems like those described with reference to FIGS. 1-4. At step 510, the method 500 includes providing an input image to a physics-constrained encoder of a VAE (Variational Autoencoder) as an input.

At step 520, the method 500 includes receiving a physics-constrained latent space of the input image from the physics-constrained encoder. At step 530, the method 500 includes receiving an output image from a generator of a cGAN (Conditional Generative Adversarial Network) that is based at least in part on the physics-constrained latent space as an input for the output image. The cGAN may also receive a condition. At step 540, the method 500 includes generating an authenticity metric based on a difference between the output image and the input image. At step 550, the method 500 includes determining the authenticity metric is in a range associated with an inauthentic image. In response to the determination, a warning, such as described previously in FIGS. 3 and 4, may be presented. At step 560, the method 500 includes associating the input image with an indication that the input image is inauthentic.

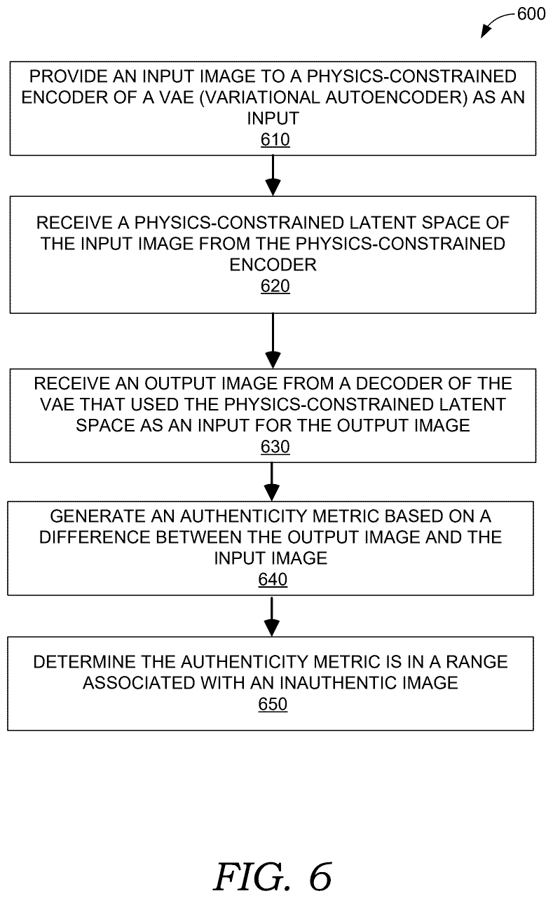

FIG. 6 is a flow diagram showing a method 600 of detecting an inauthentic image, in accordance with some embodiments of the present disclosure. Method 600 may be performed on or with systems like those described with reference to FIGS. 1-4.

At step 610, the method 600 includes providing an input image to a physics-constrained encoder of a VAE (Variational Autoencoder) as an input. At step 620, the method 600 includes receiving a physics-constrained latent space of the input image from the physics-constrained encoder. At step 630, the method 600 includes receiving an output image from a decoder of the VAE that is based at least in part on the physics-constrained latent space as an input for the output image. At step 640, the method 600 includes generating an authenticity metric based on a difference between the output image and the input image. At step 650, the method 600 includes determining the authenticity metric is in a range associated with an inauthentic image. At step 660, the method 500 includes associating the input image with an indication that the input image is inauthentic.

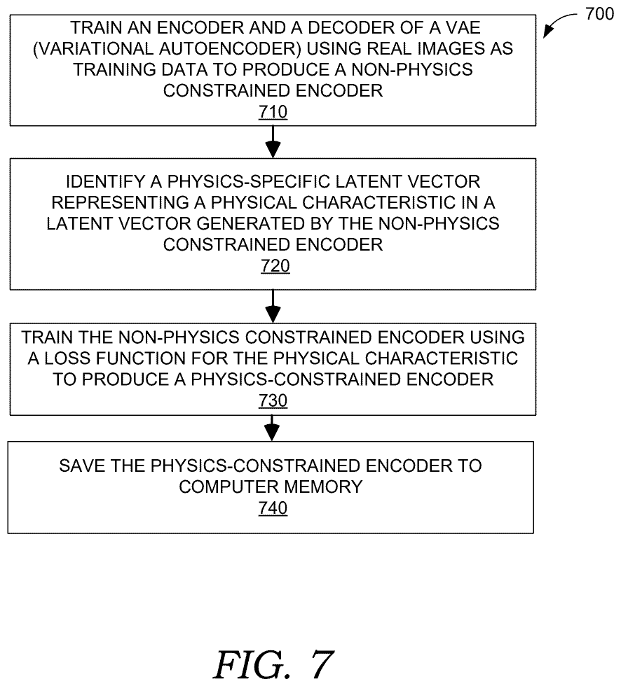

FIG. 7 is a flow diagram showing a method 700 of training a model to detect an inauthentic image, in accordance with some embodiments of the present disclosure. Method 700 may be performed on or with systems like those described with reference to FIGS. 1-4.

At step 710, the method 700 includes training an encoder and a decoder of a VAE (Variational Autoencoder) using real images as training data to produce a non-physics constrained encoder. At step 720, the method 700 includes identifying a physics-specific latent vector representing a physical characteristic in a latent vector generated by the non-physics constrained encoder. At step 730, the method 700 includes training the non-physics constrained encoder using a loss function for the physical characteristic to produce a physics-constrained encoder. At step 740, the method 700 includes saving the physics-constrained encoder to computer memory.

### Example Operating Environment

Referring to the drawings in general, and initially to FIG. 8 in particular, an example operating environment for implementing aspects of the technology described herein is shown and designated generally as computing device 800. Computing device 800 is but one example of a suitable computing environment and is not intended to suggest any limitation as to the scope of use of the technology described herein. Neither should the computing device 800 be interpreted as having any dependency or requirement relating to any one or combination of components illustrated.

The technology described herein may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. The technology described herein may be practiced in a variety of system configurations, including handheld devices, consumer electronics, general-purpose computers, specialty computing devices, etc. Aspects of the technology described herein may also be practiced in distributed computing environments where tasks are performed by remote-processing devices that are linked through a communications network.

With continued reference to FIG. 8, computing device 800 includes a bus 810 that directly or indirectly couples the following devices: memory 812, one or more processors 814, one or more presentation components 816, input/output (I/O) ports 818, I/O components 820, and an illustrative power supply 822. Bus 810 represents what may be one or more busses (such as an address bus, data bus, or a combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 8 is merely illustrative of a computing device that may be used in connection with one or more aspects of the technology described herein. Distinction is not made between such categories as “workstation,” “server,” “laptop,” “handheld device,” etc., as all are contemplated within the scope of FIG. 8 and refer to “computer” or “computing device.”

Computing device 800 typically includes a variety of computer-readable media. Computer-readable media may be any available media that may be accessed by computing device 800 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 812 includes computer storage media in the form of volatile and/or nonvolatile memory. The memory 812 may be removable, non-removable, or a combination thereof. Example memory includes solid-state memory, hard drives, optical-disc drives, etc. Computing device 800 includes one or more processors 814 that read data from various entities such as bus 810, memory 812, or I/O components 820. Presentation component(s) 816 present data indications to a user or other device. Example presentation components 816 include a display device, speaker, printing component, vibrating component, etc. I/O ports 818 allow computing device 800 to be logically coupled to other devices, including I/O components 820, some of which may be built in.

Illustrative I/O components include a microphone, joystick, game pad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided to digitally capture freehand user input. The connection between the pen digitizer and processor(s) 814 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may coexist with the display area of a display device, be integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 800. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 800. The computing device 800 may be equipped with depth cameras, such as stereoscopic camera systems, infrared camera systems, RGB camera systems, and combinations of these, for gesture detection and recognition. Additionally, the computing device 800 may be equipped with accelerometers or gyroscopes that enable detection of motion. The output of the accelerometers or gyroscopes may be provided to the display of the computing device 800 to render immersive augmented reality or virtual reality.

A computing device may include a radio 824. The radio 824 transmits and receives radio communications. The computing device may be a wireless terminal adapted to receive communications and media over various wireless networks. Computing device 800 may communicate via wireless policies, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 policies.

### EMBODIMENTS

The technology described herein has been described in relation to particular aspects, which are intended in all respects to be illustrative rather than restrictive. While the technology described herein is susceptible to various modifications and alternative constructions, certain illustrated aspects thereof are shown in the drawings and have been described above in detail. It should be understood, however, that there is no intention to limit the technology described herein to the specific forms disclosed, but on the contrary, the intention is to cover all modifications, alternative constructions, and equivalents falling within the spirit and scope of the technology described herein.

What is claimed is:

1. One or more computer storage media comprising computer-executable instructions that when executed by computing device performs a method of detecting an inauthentic image, the method comprising:
providing an input image to a physics-constrained encoder of a VAE (Variational Autoencoder) as an input;
receiving a physics-constrained latent space of the input image from the physics-constrained encoder;
receiving an output image from a generator of a cGAN (Conditional Generative Adversarial Network) based at least in part on the physics-constrained latent space as an input for the output image;
generating an authenticity metric based on a difference between the output image and the input image;
determining that the authenticity metric is in a range associated with an inauthentic image; and
associating the input image with an indication that the input image is inauthentic.

2. The media of claim 1, wherein the method further comprises providing a warning with the input image.

3. The media of claim 1, wherein the method further comprises identifying a portion of the input image as being inauthentic.

4. The media of claim 3, wherein the method further comprises generating a textual description of an identified authenticity problem within the portion of the input image.

5. The media of claim 1, wherein the cGAN and the VAE are trained together using a multi-objective framework.

6. The media of claim 1, wherein a physics constraint of the physics-constrained encoder is lighting consistency and is enforced during training using a loss function based on a Lambertian reflection model.

7. The media of claim 1, wherein a physics constraint of the physics-constrained encoder is depth consistency and is enforced during training using a loss function based a monocular depth estimation model.

8. The media of claim 1, wherein the physics-constrained encoder includes a physics constraint layer trained to constrain the physics constrained latent space to a specific physical characteristic.

9. A method of detecting an inauthentic image comprising:
providing an input image to a physics-constrained encoder of a VAE (Variational Autoencoder) as an input;
receiving a physics-constrained latent space of the input image from the physics-constrained encoder;
receiving an output image from a decoder of the VAE that is based at least in part on the physics-constrained latent space as an input for the output image;
generating an authenticity metric based on a difference between the output image and the input image;
determining the authenticity metric is in a range associated with an inauthentic image; and
associating the input image with an indication that the input image is inauthentic.

10. The method of claim 9, wherein the method further comprises providing a warning with the input image.

11. The method of claim 9, wherein the method further comprises:
receiving a second output image from a generator of a cGAN (Conditional Generative Adversarial Network) that is based at least in part on the physics-constrained latent space as an input for the output image; and
wherein the authenticity metric is also based on a difference between the input image and the second output image.

12. The method of claim 11, wherein the cGAN and the VAE are trained together using a multi-objective framework.

13. The method of claim 9, wherein a physics constraint of the physics-constrained encoder is lighting consistency and is enforced during training using a loss function based on a Lambertian reflection model.

14. The method of claim 9, wherein the difference between the output image and the input image is calculated using mean squared error.

15. The method of claim 14, wherein the difference between the output image and the input image is calculated using peak signal-to-noise ratio.

16. A method of training a detection model to identify an inauthentic image, comprising:
training an encoder and a decoder of a VAE (Variational Autoencoder) using real images as training data to produce a non-physics constrained encoder;
identifying a physics-specific latent vector representing a physical characteristic in a latent vector generated by the non-physics constrained encoder;
training the non-physics constrained encoder using a loss function for the physical characteristic to produce a physics-constrained encoder; and
saving the physics-constrained encoder to computer memory.

17. The method of claim 16, wherein the physics-constrained encoder includes a physics regulation layer that forces an output latent vector to adhere to a learned physics constraint.

18. The method of claim 17, wherein nodes in layers other than the physics regulation layer are frozen during training of the physics-constrained encoder.

19. The method of claim 18, further comprising training a generator and a discriminator of a cGAN (Conditional Generative Adversarial Network) using a mixture of real and inauthentic images as training data to produce a non-physics constrained generator.

20. The method of claim 19, wherein the cGAN and the VAE are trained together using a multi-objective framework.
